(19) United States
(12) Patent Application Publication
(10) Pub. No.: US 2008/0293030 A1
(43) Pub. Date: Nov. 27, 2008

(54) METHOD AND SYSTEM FOR OFFERING EDUCATIONAL COURSES OVER A NETWORK

(75) Inventors: Gail Rooks Hixon, Woodinville, WA (US); Keith Michael Faris, Woodinville, WA (US)

Correspondence Address: PERKINS COIE LLP;PATENT-SEA, P.O. BOX 1247, SEATTLE, WA, 98111-1247, US

(73) Assignee: The Riesling Group, Inc., Woodinville, WA (US)

(21) Appl. No.: 11/751,953

(22) Filed: May 22, 2007

(51) Int. Cl. G09B 7/00

(52) U.S. Cl. 434/322

(57) ABSTRACT

A software and/or hardware facility for enabling an institution to construct educational courses that may be delivered over a network is disclosed herein. The facility simplifies the construction of courses by allowing course materials to be reused and tailored on an institution-by-institution basis. Institutions may select an existing course and modify the existing course by adding, deleting, or modifying course content, sequencing, assignments, test materials, gating events, and/or course parameters. Once constructed by an institution, the course may be added to the institution's course catalog for delivery over a network such as the Internet or an intranet. In some embodiments a student is allowed to enroll in and complete a course at their own pace.

### BACKGROUND

An increasing number of universities, colleges, corporations, businesses, individuals and other institutions offer educational courses over a network, such as the Internet or an intranet. The number of people interested in taking a course over a network is also expanding as employers, companies and schools are able to provide training, instruction and education to more than just the traditional student. For example, many individuals are interested in continuing their education on a part or full-time basis while they are working or assuming other responsibilities. Other individuals may have a specific interest and wish to take only a single course regarding that interest. Offering a course over a network generally allows students, employees, or those simply interested in a subject to participate in the course according to their own schedules without being required to physically attend a class. Institutions are therefore able to attract more students and/or better meet the needs of existing students by allowing the students to participate in a course at the students' convenience.

While students and institutions may benefit from courses offered over a network, institutions still face the challenge of creating and managing these courses. As an institution's catalog of courses offered over a network grows and varies, institutions may find themselves spending a greater amount of time building courses from scratch. Additionally, although students may remotely participate in a course, students are often required to adhere to a schedule and proceed through the course according to a predefined regimen. Similar to an in-class environment, institutions and students would therefore benefit from a flexible system that would streamline the construction of courses by institutions and delivery of courses to students.

### BRIEF DESCRIPTION OF THE DRAWINGS

FIG. 1 is a block diagram of a hardware and/or software facility for offering educational courses over a network.

FIG. 2 is a representative screenshot depicting a user interface that enables a student to participate in a course offered over a network.

FIG. 3 is a representative screenshot depicting a user interface that enables a student to view a course outline.

FIG. 4 is a flow diagram of a method of creating an educational course that may be delivered over a network.

FIGS. 5A-5E are block diagrams that illustrate stored information used to construct and deliver courses.

FIG. 6 is a flow diagram of a method of delivering a course to a student over a network.

### DETAILED DESCRIPTION

A software and/or hardware facility is disclosed for enabling an institution to construct educational courses that may be delivered over a network. An institution may be a college, university, educational institution, corporate entity, business, individual or anyone interested in offering educational materials to one or more remote users. Offering educational courses over a network allows students to enroll and participate in a course without physically attending the course. The facility enables courses to be easily constructed by institutions, and course materials to be reused and tailored on an institution-by-institution basis. Institutions may select an existing course and modify the existing course by adding, deleting, or modifying course content, sequencing, assignments, testing materials, gating events, and/or course parameters. Once constructed by an institution, the course may be added to the institution's course catalog for delivery over a network such as the Internet or an intranet. By providing a simple interface that enables institutions to construct courses that reuse existing course materials, an institution may construct many different versions of a course that are each tailored to meet the needs of a different group of students.

In some embodiments a student is allowed to enroll in and complete a course at their own pace. That is, the student may enroll in a course at any time and take as long as necessary to complete the course in order to receive credit. In some embodiments, institutions may restrict certain parameters of the course, such as the starting and ending dates or the duration of the course. Also, in some embodiments an institution may enact gating events to control the progress of the student through the course. For example, students may not be allowed to proceed until completing a quiz or receiving a certain score on a series of assignments. Those skilled in the art will appreciate that the disclosed facility provides significant flexibility for institutions and students for learning in a networked environment.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

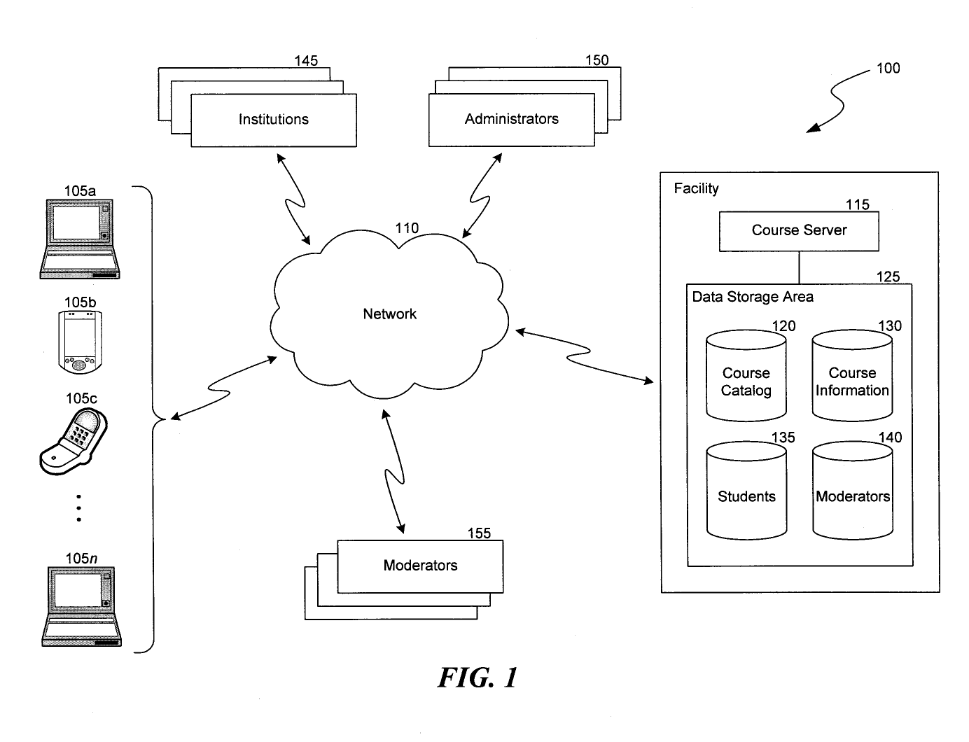

FIG. 1 is a block diagram that illustrates the components of a facility 100 for offering courses in a networked environment. The facility 100 is capable of retrieving courses created by institutions and delivering the courses to students over a network 110, such as the Internet, intranet or other network. Students are able to access the courses remotely, using computers, portable digital assistants, mobile phones or any other computing device 155a . . . 155n that is connected to the network 110 via a wired or wireless connection. As will be discussed in additional detail herein, students may enroll in and complete courses at their own pace. The disclosed facility thereby makes it very convenient for students to take courses, as students can participate in a course remotely and in a manner that is consistent with their personal and professional schedules.

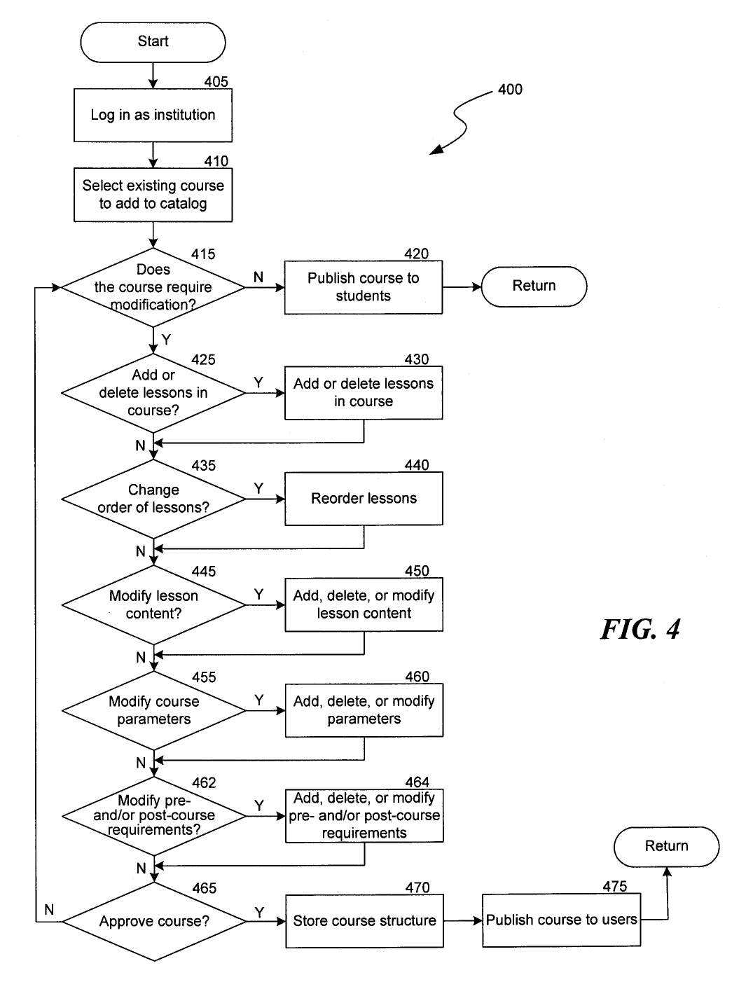

To deliver courses over the network 110, the facility is comprised of one or more course servers 115 that are connected to a data storage area 125. The facility includes one or more software applications that enable the courses to be constructed, managed, and delivered as disclosed herein. The data storage area 125 includes a number of databases that are maintained by the facility to implement the disclosed functionality, including a course catalog database 120 that maintains a list of courses that are available at each institution utilizing the facility, a course information database 130 that stores information such as lesson content and structure, assignment and testing materials, sequencing information, and/or course parameters (as described in more detail in FIG. 4), a student database 135 that stores student-specific information such as eligibility to enroll, enrollment status, payment history, and/or personal identification information, and a moderator database 140 that stores information regarding moderators that are enabled by institutions to proctor or monitor student progress through the course. Institutions 145, administrators 150, and moderators 155 may remotely access the facility 100 through the network 110. Institutions are entities that typically pay a fee to utilize the facility, whereas administrators are employed by the operator of the facility. Institutions 145 may create courses, manage enrollment, and process credits. Administrators may perform all of the activities of an institution, as well as provide customer service and generally ensure that courses are functioning as desired. Moderators 155 may be employed by an institution or by an operator of the facility and may remotely access the facility 100 through the network 110 to monitor and assess the progress of students through courses.

The term “database” is used generically herein to indicate a collection of records stored in a computer in a systematic way. While four databases are depicted in the data storage area 125, those skilled in the art will appreciate that a greater or lesser number of databases may be utilized to implement the disclosed facility. The depicted databases are merely for pedagogical purposes.

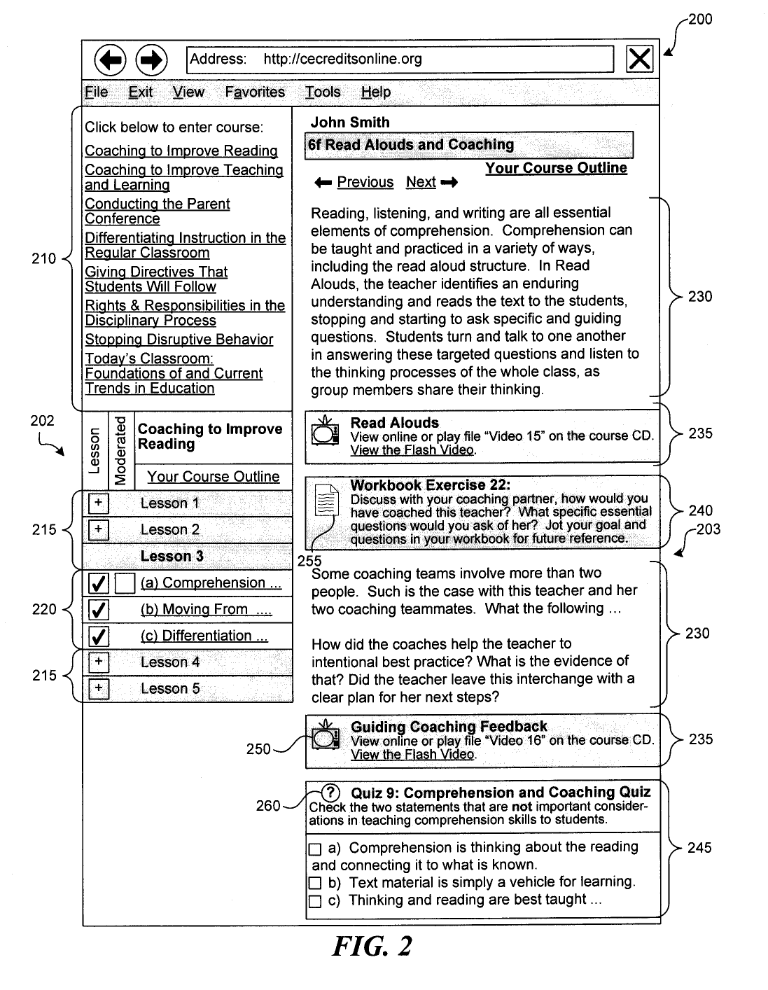

FIG. 2 is an example of a user interface 200 such as one that may be generated by the facility 100 when a student participates in a course. The user interface 200 includes different regions that may be populated by the facility with the course content, such as a course and lesson selection area 202 and a lesson presentation area 203. The course and lesson selection area 202 provides a list 210 of courses that a student has enrolled in with a particular institution. The course list 210 may also display courses that a user is eligible for, but has not yet registered for. After a student selects a course from the course list 210, the facility presents the user with a list 215 of the lessons in the selected course. Selecting one of lessons causes the lesson list to expand and a list 220 of the sub-lessons in the selected lesson to be displayed to the student. Lesson content may differ for each lesson or for each course. For example, a lesson may be comprised of multiple sub-lessons containing various teaching and informational materials, or a lesson may include teaching materials without sub-lessons. The facility may indicate (by highlighting, checkmark, or other visual indication) in the sub-lesson list 220 whether the student has progressed through the lesson as well as whether the sub-lesson is moderated. After a user selects a lesson from the listing 215 or a sub-lesson from the listing 220, the facility presents the selected lesson material to the student in the lesson presentation area 203.

In the lesson presentation area 203, the facility displays the lesson or sub-lesson materials to a student to enable the student to participate in the course. As depicted in FIG. 2, the lesson materials may be segmented according to the type of materials and structure of the lesson as constructed by the offering institution. It will be appreciated that lesson material may consist of a variety of different types of information, including but not limited to lesson content such as text, audio, video, assignments and testing materials, on-line discussions, etc. For example, in some embodiments the facility presents text passage segments 230, audio or video segments 235, exercises or assignments segments 240, and testing segments 245 to the student. While the lesson presentation area 203 and lesson material are depicted in a particular format in FIG. 2, it will be appreciated that the layout of the course materials may take a number of different forms, as dictated by the institution. Certain visual cues, such as symbols or icons, may be displayed by the facility to quickly indicate to the student what type of course material the lesson contains. For example, FIG. 2 depicts a television icon 250 indicating a video segment at 235, a paper icon 255 indicating an exercise or assignment at 240, and a question mark icon 260 indicating a quiz at 245.

It will be appreciated that the user interface 200 presented in FIG. 2 is merely representative and that educational courses could be presented by the facility to the user in many different forms. For example, text passage segments 230 may be presented in a pop-up window or on another page in the network (such as another web page) and accessed via a hyperlink. Alternatively, text passage segments 230 may provide a reference by page, section or chapter to supplemental course material such as text books. Similarly, audio or video segments 235 may be accessed by the student while remaining within the lesson presentation area 203, or the student may access the audio or visual segments from a separate media player. Exercises or assignment segments 240 or testing segments 245 may also be presented in different formats than those shown in FIG. 2. For example, FIG. 2 depicts a quiz that allows a student to select answers from a defined list, however it will be appreciated that quizzes (and tests, exercises or assignments, etc.) may be presented in other formats, such as but not limited to true/false, multiple choice, short answer or essay. Testing materials may require active or passive participation by the student. For example, a student may be required to actively submit quiz answers, while at other times a student may only be required to passively watch a video to proceed through the lesson. A student's completed testing materials may be submitted over the networked environment, or in other ways, for example by mail or in person. Other changes to the user interface 200 depicted in FIG. 2 will be readily apparent to those skilled in the art.

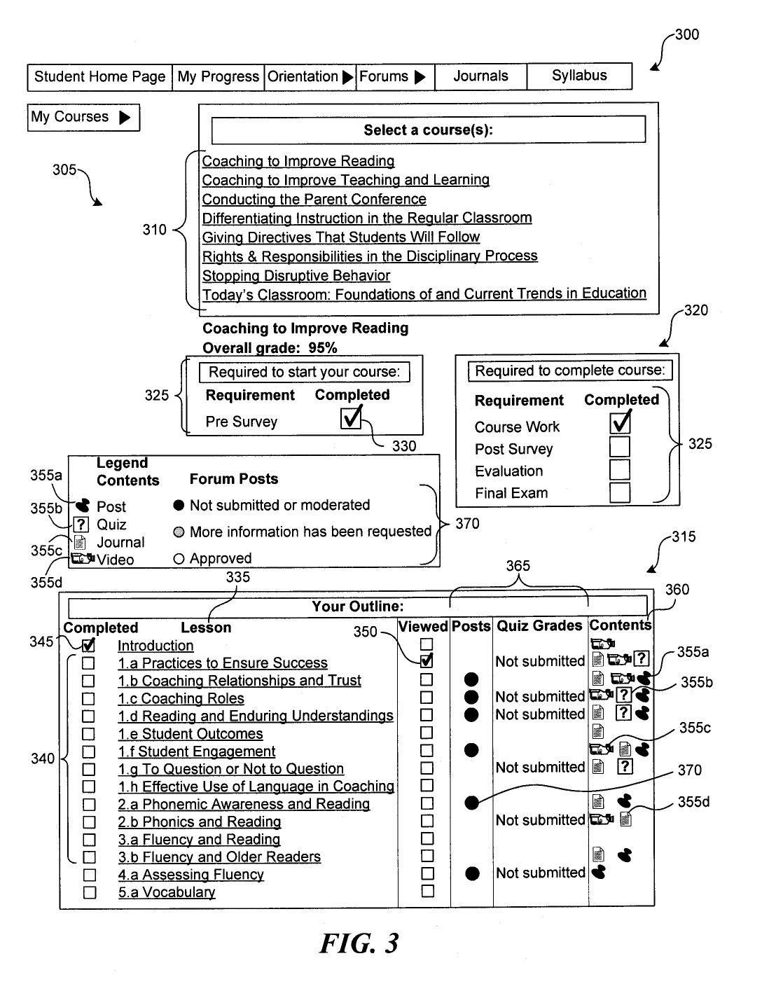

Courses such as that depicted in FIG. 2 are constructed by an institution to include the desired teaching materials. FIG. 3 is an example of a user interface 300 for students to view an outline of a course. The user interface 300 is generally comprised of a course selection area 305, a course outline area 315, and a course status area 320, which are populated by the facility. The course selection area 305 operates in a similar fashion to the course and lesson selection area 203 of FIG. 2, and provides a list 310 of the courses that a student has enrolled in with a particular institution. When a course is selected from the list 310 of courses, the facility displays the status of the student's progress through the course in the course status area 320. As depicted in FIG. 3 the facility displays requirements 325 that must be completed before starting a course or before completing a course, and also displays an indication of the progress of the student towards meeting the requirements. For example, in FIG. 3 the facility indicates that the student has submitted a pre-course survey (a requirement before starting the course) by the inclusion of a checkmark 330 next to the requirement. In some embodiments, the facility also displays and dynamically updates the student's overall grade in the course in the course status area.

The facility also displays an outline of the course in the course outline area 315. As depicted in FIG. 3, the facility populates the course outline area 315 to display a listing 335 of the lessons and respective sub-lessons 340 of the selected course. Many of the same graphical icons and user interface features depicted in FIG. 2 are also present in FIG. 3. For example, the facility indicates whether a student has completed a sub-lesson by inclusion of a checkmark 345 next to the sub-lesson indicating completion. Additionally, the facility indicates whether a student has viewed, but not yet completed, a sub-lesson by the inclusion of a checkmark 350 next to the sub-lesson. A legend displays various symbols or icons 355a-355d indicating what type of course material a sub-lesson contains, such as a discussion board posting icon 355a, a quiz icon 355b, an exercise or assignment icon 355c, and a video icon 355d. The appropriate icons 355a-355d for each sub-lesson are presented in a contents area 360 of the course outline area 315. The facility also displays the status of gating events such as quizzes or discussion board postings in a gating events area 365. In the gating events area 365, the facility can indicate whether gating events or other requirements have been fulfilled. For example, status icons 370 may be displayed in the gating events area 365 to indicate whether a specific gating event has been submitted, approved, reviewed, or if more information is required. Accordingly, the facility provides a user interface to enable students to readily assess what course materials they will encounter or have already completed while enrolled in a course. One skilled in the art will appreciate that a course outline may be presented to a student in many different forms and that the course outline area 315 is merely a representative interface to allow the student to assess the course material and proceed through the course their own pace.

FIG. 4 is a flow diagram of a flexible process 400 implemented by the facility that enables an institution to construct a course that may be uniquely offered by that institution. To construct a course, an institution logs into the facility at a block 405. By requiring a secure log-in to the facility, an institution is able to ensure that only authorized users are allowed to add or modify courses that are offered by the institution. The secure log-in also uniquely identifies the institution to the facility, so that any subsequent courses that are constructed by the institution may be stored in association with that institution. At a block 410 the institution selects a course to add to its catalog of courses that are offered via a network. The facility offers a list of existing courses that have already been developed and stored in the facility by the facility operator or by third parties. If an existing course is found to be suitable in part or in full by the institution, the institution may select the course from the existing course list. Alternatively, the institution may be given the option (not shown) to create its own course by uploading course information, assignments, tests, and by specifying various course parameters. Courses offered by an institution may include courses covering various subjects or topics, from traditional courses such as math or history, to vocational courses, equipment training courses, or any other type of educational course.

After selecting a course from the existing course list, at a decision block 415 the facility queries the institution as to whether the course requires modification before making it available to students. Those skilled in the art will appreciate that a course may be modified in a variety of ways, including, but not limited to changing the content (e.g., text, video or audio components) of the lessons and sub-lessons, changing the order of the lessons, adding or omitting testing materials and modifying various parameters associated with the lessons or the course, such as the length of time allowed to complete the course. If the course does not require modification, at a block 420 the facility publishes the course to students by adding the course to the course catalog of the associated institution and making the course available to students of that institution for enrollment.

If the institution indicates that the course requires modification, processing continues to a decision block 425. At decision block 425, the facility queries the institution as to whether lessons need to be added to or deleted from the course. If the institution indicates that lessons need to be added or deleted, at a block 430 the facility provides an interface to the institution that allows the institution to add lessons to a course (e.g., by uploading new lessons to the facility, by copying lessons from existing courses maintained by the facility, etc.) or to delete lessons from a course. After lessons have been added or deleted from a course by the institution, or if no lessons were required to be added or deleted to a course, processing continues to a decision block 435.

At decision block 435 the facility queries the institution as to whether the ordering or sequencing of the lessons needs to be changed in the course. For example, an institution may alter the order in which a student progresses through the lessons in a course. If a change to the lesson order is indicated by the institution, at a block 440 the facility provides an interface to the institution that allows the institution to reorder the lesson blocks in the course by moving lessons in front of or behind other lessons. After the ordering of lessons has been completed by the institution, or if no reordering was required, processing continues to a decision block 445.

At decision block 445, the facility queries the institution as to whether any modification to the lesson content needs to be made in the course. Those skilled in the art will appreciate that all forms of teaching materials may be included in a lesson, including but not limited to text passages, audio segments, video segments, exercises, assignments, tests, quizzes, on-line discussions, etc. If any portion of a lesson or all of a lesson is desired to be modified by the institution, at a block 450 the facility provides an interface that allows all or portions of the lesson content to be added, deleted or modified. Institutions may modify the lesson content by editing the existing content, adding new content by uploading or copying new content or by deleting content. Once the lesson content has been modified by the institution, processing continues to a decision block 455.

At decision block 455, the facility queries the institution as to whether any modification to the course parameters is required. The parameters associated with the course may include a variety of information regarding the course, including but not limited to data regarding whether the course is offered for credit and the number of credits for that course, and whether the course is graded, pass/fail or not graded. The parameters may also include time constraints that may be imposed on students enrolled in the course, such as the pace at which a student must complete a lesson. For example, an institution may require that the student complete the lesson by a specified date or within a specified amount of time, such as one week from beginning the lesson. The institution may also allow the student to complete the lesson as fast or slow as desired, or not to allow the student to complete the lesson faster than a predetermined time. If the institution decides to modify the course parameters, at a block 460 the facility provides an interface that allows all or portions of the course parameters to be specified by the institution.

After the course parameters have been modified, or if no modifications to the course parameters are required, processing continues to a decision block 462. At decision block 462 the facility queries the institution as to whether any modification to pre- and/or post-course requirements is required. Pre- and/or post-course requirements associated with the course may include informational queries that help the institution to better tailor the course to the student's or future students' needs. For example, the pre- and/or post-course requirements may include a demographic survey or an evaluation of the student's expectations or satisfaction regarding the course. The pre- and/or post-course requirements may also include a student assessment, which may help the institution to customize the course according to the student's ability. In some embodiments, the pre- and/or post-course requirements can include directions for validating completion of the course, such as directions to the student for receiving a certificate, obtaining credit from a sponsoring institution, making payment to an institution, or archiving the student's activity regarding the course. Those skilled in the art will appreciate that the pre- and/or post-course requirements are not limited to the examples listed, but may include any requirement desired by the institution. If the institution decides to modify the pre- and/or post-course requirements, at a block 464 the facility provides an interface that allows all or part of the pre- and/or post-course requirements to be specified by the institution.

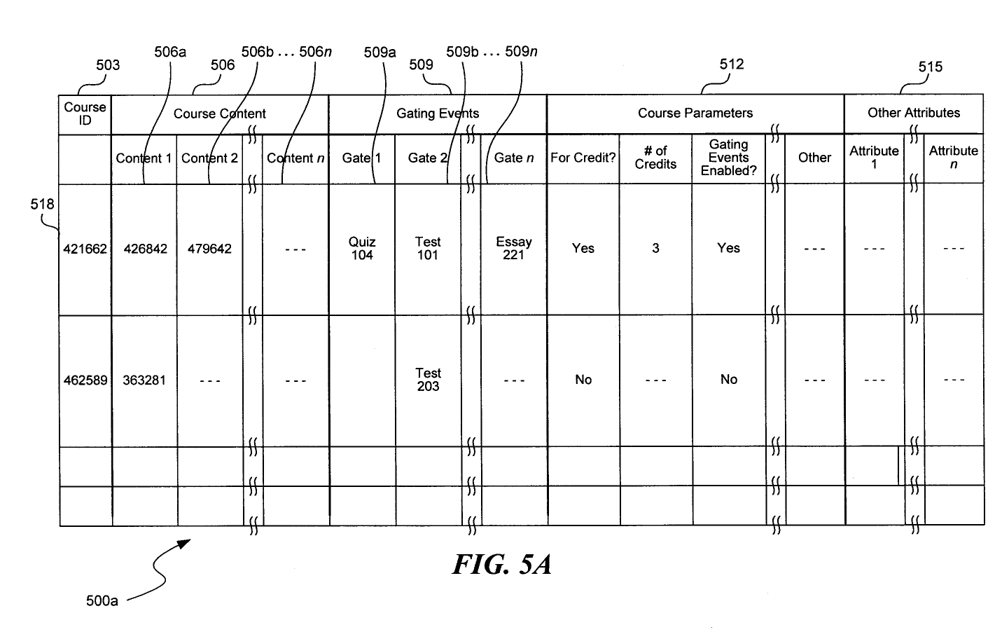

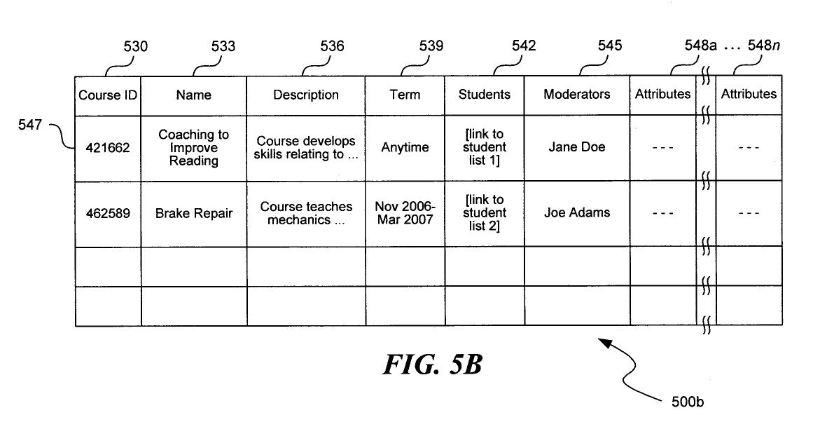

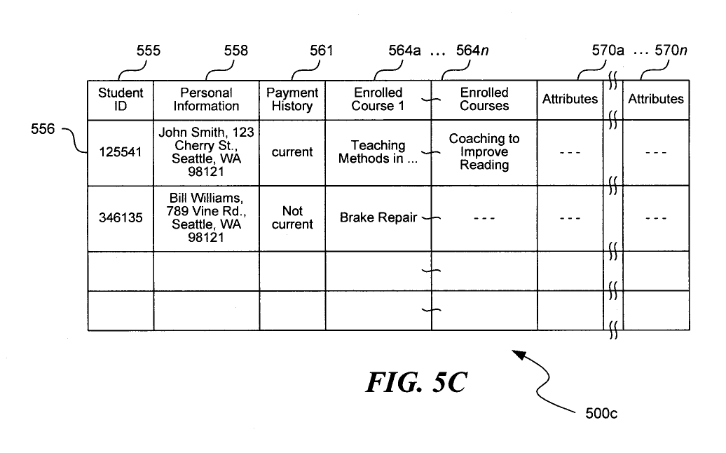

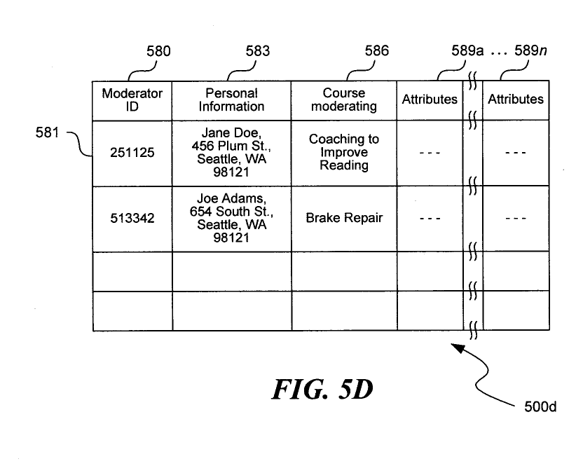

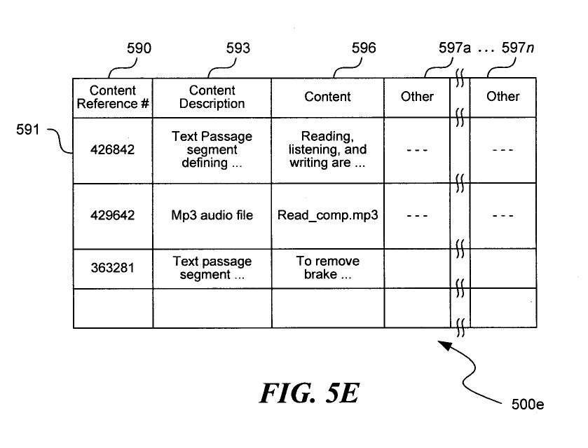

After the pre- and/or post-course requirements have been modified, or if no modifications to the pre- and/or post-course requirements are required, processing continues to a decision block 465. At decision block 465 the facility queries the institution as to whether the course may be approved. If the institution approves the course, at a block 470 the course is stored by the facility as described in more detail in FIG. 5. If the institution does not approve the course, processing returns to decision block 425 where the institution is allowed to continue to modify the course. After the course is stored in association with the institution, at a block 475 the course is published by the facility to the institution's course catalog and made available to students who are eligible to enroll and participate in the course. While the process 400 is depicted in a flow chart, those skilled in the art will appreciate that an interface presented to the institution by the facility may allow the institution to select various modifications to the course in any order and at any time. Such an interface may include a menu or other control that allows the institution to quickly select and manipulate a course. The process 400 is merely intended to show the range of modifications that may easily be made to a course by the institution.

One of the benefits of allowing an institution to easily modify existing courses to create new courses is that it allows the institution to tailor courses to groups of students. For example, an institution may quickly create three different versions of a course, with one version directed to students taking the course for a credit, another version directed to students taking the course for credit on a pass/fail basis, and still another version directed to students merely auditing the course. By allowing the institution to quickly and easily change the course content, sequencing, and parameters, a greater variety of students may be served.

FIGS. 5A-5E are block diagrams of representative tables 500a-500e that store information contained in one or more databases in the data storage area 125. While some of the fields of the databases have been presented in textual form in table 500a-500e for the benefit of this description, it will be appreciated that an actual implementation of the tables may represent the stored information by unique codes, by a search index, or in another form. On a periodic basis, the information in the table may be updated to reflect changes to the course, such as changes to the course content, gating events or course parameters.

FIG. 5A is a block diagram of a representative table 500a that stores course information in the course information database 130. Each record in the table corresponds to a single course and includes course information such as a course identification number, course content, gating events, course parameters and other attributes. Specifically, the table includes a course ID field 503, a course content section 506, a gating events section 509, a course parameters section 512, and/or other attributes section 515. The course ID field 503 contains a unique identifier that is assigned by the facility to the course. For example, in a representative record 518 the facility has assigned the course an identifier number “421662.” The course ID uniquely identifies the course and allows the facility to easily reference a particular course. The course content section 506 contains course content and materials that may be represented by content reference numbers that uniquely identify a piece of course content or material. These content reference numbers may be expressed as links, pointers, etc., to reference and correspond to a data structure containing the course content, such as a course content table 500e as discussed in more detail below. Course content and materials may include, but are not limited to, text passages, audio files (e.g., mp3 or other audio formats), video files (for example, a link to a web site containing a video clip), assignments and testing materials, on-line discussions, or other materials that may be presented by the facility to the student. For example, the record 518 indicates course content reference numbers 426842 and 479642, which are linked to table 500e.

The gating events section 509 contains one or more gating events that the institution may use to track the progress of students. For example, the record 518 indicates that a quiz 509a and a test 509b must be completed before a student is allowed to progress within a course or between a series of courses. One or more fields (not shown) may be provided in the gating events section 509 to specify the minimum score necessary for each gating event for a student to be considered to have completed the gating event. Other gating events, such as an essay 509n may also be contained in the gating events section 509. The number of gating events for a particular course is specified by the institution, and in some cases, no gating events may be specified for a course.

The course parameters section 512 contains information relating to the structure and various options of the course, such as if the course is offered for credit and how many credits, if it is pass/fail or graded, any time constraints imposed on the course, if the gating events are enabled for the course, or other parameters. For example, the parameters associated with record 518 indicate that the course is offered for credit, that it has three credits, that it is graded, and that gating events have been enabled. Other course parameters may be specified in the course parameters section 512 as well. The attributes section 515 associated with each course record contains any other information relating to a course that might be specified by the institution.

FIG. 5B is a block diagram of a representative table 500b that stores information in the course catalog database 120. Each record in the table corresponds to a single course and includes attributes such as the course name and description, when the course is offered, how many students are enrolled in the course, who is moderating the course, and other attributes. Specifically, a course ID field 530 contains the unique identifier that is assigned by the facility to the course. A course name field 533 contains an identifying name for the course as selected by the institution. Although a course may have a unique ID as generated by the facility or created by the institution, a course name may be more easily identifiable for users and descriptive of the course content when displayed in a course catalog. A course description field 536 contains a brief description of the course to enable students to decide if they would like to enroll in the course. Additionally, the description field 536 may provide criteria for enrolling in the course, such as prerequisite courses. A term field 539 contains information regarding when the course is offered for students. For example, some courses may always be available and therefore offered in the catalog, while other courses may only be in the catalog for certain periods of time, such as a spring semester for example. A student field 542 contains a link to a data structure containing a list of students that are enrolled in the course. Such a list may be stored in a student table 500c, such as will be described below. A moderator field 545 indicates who, if any, is employed as a moderator for the course to oversee the progress of the students through the course. A moderator can be assigned on a student, course, or lesson basis, or any other basis suitable for monitoring a student's progression through a course. It will be appreciated that that the representative table 500b is not limited only to the attributes shown, but may include other fields containing information relating to the course, such as attributes 548a . . . 548n associated with each course record. A sample course is reflected in record 547. The course in record 547 is identified by the course ID “421662,” by the name “Coaching to Improve Reading,” and by a description that may be included in a course catalog. The course is offered anytime, is moderated by “Jane Doe,” and the record contains a link to students that are currently enrolled in the course. Table 500b is designed to contain any additional information that is required by the institution to sufficiently specify a course for operation by the facility.

FIG. 5C is a block diagram of a representative table 500c that stores student information in the student database 135. Each record in the table 500c corresponds to a single student and includes attributes such as a student ID, personal and contact information, payment history, eligibility to enroll, courses enrolled in, and other attributes about the student. Specifically, a student ID field 555 contains a unique identifier that is assigned by the facility to a student. For example, in a representative record 556, the facility has assigned the student an identification number “125541.” The student ID uniquely identifies the student and allows the facility to easily reference a particular student. A personal information field 558 contains personal information regarding each student, such as their name, address and contact information, or other relevant personal information. A payment history field 561 indicates, if applicable, if the student has appropriately made payment to the institution for participating in courses in which the student is enrolled. The payment history of the student may be used to determine whether a student is eligible to enroll in additional courses. Enrolled courses fields 564a . . . 564n contain a list of courses in which the student is currently enrolled. The enrolled courses fields enable the facility to track how many courses a student is taking and may also construct a list of students that are enrolled in any particular course. It will be appreciated that the representative table 500c is not limited only to the attributes shown, but may include other attributes 570a . . . 570n which may contain additional information pertaining to each student.

FIG. 5D is a block diagram of a representative table 500d that stores information in the moderators database 140. Each record in the table 500d corresponds to a single moderator and includes attributes such as a moderator ID, personal and contact information, courses moderating, and other attributes associated with a moderator. Specifically, a moderator ID field 580 contains a unique identifier assigned by the facility to the moderator, enabling the facility to easily reference a particular moderator. A personal information field 583 contains personal information regarding each moderator, such as their name, address or contact information, or other relevant personal information. A course moderating field 586 indicates which courses the moderator is currently moderating. For example, in a representative record 581, the facility has assigned the moderator identification number “251125” and indicates that the moderator is moderating a course named “Coaching to Improve Reading”. It will be appreciated that that the representative table 500d is not limited only to the attributes shown, but may include other attributes 589a . . . 589n that are associated with other moderator information.

FIG. 5E is a block diagram of a representative table 500e that stores course content and/or materials in the course information database 130. Each record in the table 500e corresponds to specific course content that may be stored or accessed by a link or pointer. When building a new course or modifying an existing course, the facility allows the institution to save time by enabling the institution to use or reuse existing course materials stored in the table 500e, or to modify or create new materials and store the modified or new materials for access when constructing a course. Accordingly, the facility does not require that the institution to build a course from scratch, but rather an institution may reference the course content stored in table 500e. A content reference number field 590 contains a unique identification assigned by the facility to the course content, enabling the facility to retrieve course information. A content description field 593 contains a brief description of the course content and/or material to enable institutions to quickly review the course content. A content field 596 contains the actual course content presented by the facility to the student. In addition to containing the actual content, the content field 596 may also contain a link or pointer to course content and materials that are stored externally to the facility. For example, in a representative record 591, the facility has assigned the content reference number “426842” and indicates that the course content contains a text passage segment defining reading comprehension, along with the actual content of the text passage. It will be appreciated that the representative table 500e is not limited only to the attributes shown, but may include other attributes 597a . . . 597n that are associated with the course content and/or materials.

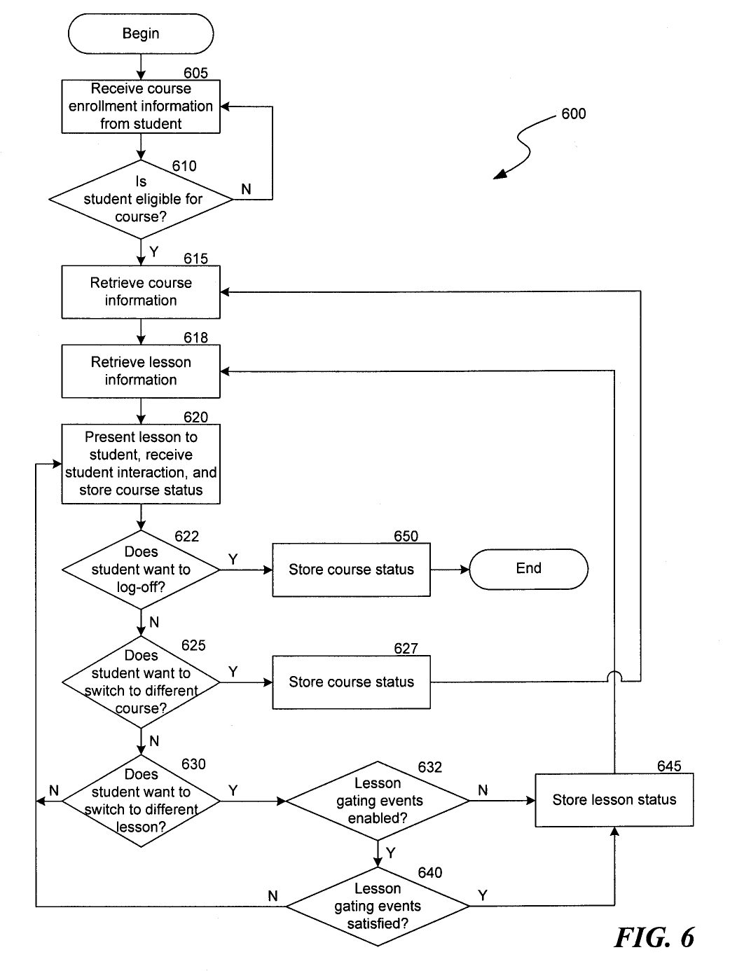

FIG. 6 is a flow diagram of an asynchronous process 600 implemented by the facility that enables a student to participate in a course at their own pace. That is, a student may enroll in, start, participate in, and finish a course according to the student's own timeline. To enroll in a course and proceed through the course at a desired pace, the facility provides an interface for a student to sign up for a course at a block 605. The sign-up associates the student with the course and enables the institution to track the number of students enrolled in the course. At a decision block 610, the facility queries the student database 135 and other records to confirm that the student is eligible to enroll in the desired course. For example, course prerequisites may be confirmed and the payment history of the student may be verified to ensure that the student is current with all fees. If the facility confirms that the student is eligible to enroll in the course, processing continues to a block 615. At block 615 the facility retrieves the information necessary to present the course to the student. Since an institution is able to quickly generate a variety of course versions using the process previously described with respect to FIG. 4, the facility must retrieve the various pieces of the course that are associated the version in which the student is enrolled. After retrieving the course information, at a block 618 the facility retrieves any information associated with the first lesson that is to be displayed to the student. Accordingly, at blocks 615 and 618 the facility retrieves the necessary course and lesson information such as course parameters, lesson content, and other gating events and attributes from the data tables that are described in FIGS. 5A-5E.

After the course and lesson information has been retrieved, at a block 620 the facility generates an interface to present the lesson to the student. As described above, FIG. 2 depicts a typical interface and lesson presentation that a student will encounter when participating in a course. Accordingly, at block 620, the facility enables the student to read lesson content, watch videos, listen to sounds clips, complete assignments and tests, or otherwise interact with any of the content that is included in the lesson. Depending on how the institution has constructed the course, a student may or may not be required to complete the course or any lessons within the course within a specified timeframe. Additionally, unless otherwise constrained by the institution, students are allowed to proceed through the lessons of the course in any order or in a sequence. For example, an institution may require a student to finish the first lesson before moving to the second lesson, or the institution may allow the student to proceed through the lessons of a course in any order. An institution may also impose time constraints for completing a lesson or a course or allow the student to complete the lessons or the course in any amount of time. At block 620, the facility also receives the content or materials associated with the student's interaction with the course and stores the course status.

In order to give students the greatest flexibility to participate in courses, students are given a number of options about when to take courses, when to switch between courses, and when to switch between lessons in courses. At a decision block 622, the facility allows a student to sign off from the facility at any time and temporarily cease participation in the currently-displayed course. If the student signs off, the status of the student in the currently-displayed course is stored at a block 650. When the student signs back on to the facility, the stored status of the student is retrieved and the student is allowed to continue in the course from where they previously left off.

At a decision block 625, the facility allows the student to switch to another course. If the student indicates a desire to switch to another course, at a block 627 the facility receives an indication from the student of the course into which they would like to switch. At block 627, the facility also stores the current status of the student in the currently-displayed course. The stored status of the student in the currently-displayed course may be used by the facility to allow the student to return to the course in the future and continue in the course from where the student previously left off. At block 615, the facility retrieves the course content associated with the course that the student would like to switch to (as well as any previously-stored status for the course), and processing continues to enable the user to proceed with the newly-selected course.

At a decision block 630, the facility allows the student to switch to another lesson within the currently-displayed course. If the student does not indicate a desire to proceed to another lesson, the student may continue with the present lesson at block 620. If the student indicates a desire to switch lessons, processing continues to a decision block 632. At decision block 632, the facility queries the course information stored in database 130 to determine whether gating events have been enabled. A variety of gating events are available to allow the institution to manage a student's progress through a course. For example, students may be required to complete a quiz or receive a certain score on a series to assignments before being allowed to proceed to another lesson or course. If the gating events have not been enabled by the institution for that course, processing continues to a block 645 where the lesson status is stored by the facility. Storing the lesson status enables the student to return to the lesson in the future and continue in the lesson from where the student previously left off. After storing the lesson status, at block 618 the facility retrieves the new lesson requested by the student. The requested lesson may be the next sequential lesson or it may be a non-sequential lesson of the student's choice.

If gating events have been enabled by the institution for the course presently being viewed by the student, processing continues to a decision block 640. At decision block 640, the facility determines whether the student has satisfied the gating events necessary to allow the student to proceed. For example, if the student has not passed a required quiz associated with a lesson the student will not be allowed to continue to the next lesson. The institution however, may construct the gating events such that a student may attempt to pass the gating event multiple times, thus allowing the student numerous opportunities to continue to the next lesson and through the course at their own pace. Alternatively, the institution may not allow the student to attempt a gating event more than one time or limit the number of times that the student may attempt the gating event in a certain period of time. For example, an institution may limit a student to attempting a quiz only once per day. If the facility indicates that the student has satisfied the gating event, processing continues to block 645 where the lesson status is stored, and then to block 618 where the lesson requested by the student is retrieved by the facility. If the student has not satisfied the gating event, processing returns to block 620 where the student may continue with the present lesson.

While the process 600 is depicted in a linear flow chart, those skilled in the art will appreciate that an interface presented to the student by the facility may allow the student to select various lessons and satisfy the gating events to proceed through a lesson according to the student's own timeframe. Such an interface may include a menu or other control that allows the student to proceed through a lesson according to the lesson content and structure as constructed by the institution. The process 600 is merely intended to illustrate the asynchronous process that a student may use to proceed through a course as constructed by an institution.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A system for enabling institutions to construct online educational courses and deliver the educational courses to students over a network, the system comprising:
a data storage area for storing course content, the course content comprising teaching materials and testing materials;
a mapping module coupled to the data storage area and maintaining an association between a plurality of courses and stored course content associated with each of the plurality of courses;
an editing module coupled to the mapping module, the editing module enabling an institution to create a new course that is to be offered by the institution by selecting course content from the stored course content, modifying the selected course content, and storing the modified selected course content as a new course in the plurality of courses, wherein the new course is a changed version of an existing course in the plurality of courses; and
a course delivery module coupled to the mapping module, the course delivery module accessing course content associated with the new course and delivering the course content over a network connection to students enrolled in the new course.

2. The system of claim 1, wherein the editing module further allows the institution to add new course content to the new course.

3. The system of claim 1, wherein the editing module further allows the institution to define one or more course parameters associated with the new course.

4. The system of claim 1, wherein the editing module further allows the institution to create one or more gating events that are associated with the new course.

5. The system of claim 1, wherein at least some of the plurality of courses are divided into a plurality of lessons.

6. The system of claim 5, wherein the editing module further allows the institution to create one or more gating events that are associated with one or more of the plurality of lessons.

7. The system of claim 5, wherein modifying the selected course content involves changing the order one or more of the plurality of lessons.

8. The system of claim 1, wherein modifying selected course content involves changing at least some of the selected course content.

9. The system of claim 1, wherein the course content is selected from the group comprising text, graphics, audio, or video.

10. A method of enabling institutions to construct online educational courses and deliver the educational courses to students over a network, the method comprising:
receiving a selection from an institution of one of a plurality of stored courses, the plurality of stored courses each containing course content;
allowing the institution to create a new course that is to be offered by the institution by editing the course content in the selected one of the plurality of stored courses to modify the presentation of the course content;
storing the modified presentation of the course content as a new course in the plurality of stored courses, wherein the new course is a changed version of the selected one of the plurality of stored courses; and
delivering the course content associated with the new course over a network connection to students enrolled in the new course.

11. The method of claim 10, further comprising allowing the institution to add new course content to the selected one of the plurality of stored courses when modifying the presentation of the course content.

12. The method of claim 10, further comprising allowing the institution to define one or more course parameters associated with the selected one of the plurality of stored courses when modifying the presentation of the course content.

13. The method of claim 10, further comprising allowing the institution to create one or more gating events that are associated with the selected one of the plurality of stored courses when modifying the presentation of the course content.

14. The method of claim 10, wherein at least some of the plurality of stored courses are divided into a plurality of lessons.

15. The method of claim 14, further comprising allowing the institution to create one or more gating events that are associated with one or more of the plurality of lessons in the selected one of the plurality of stored courses when modifying the presentation of the course content.

16. The system of claim 14, further comprising allowing the institution to change the order of one or more of the plurality of lessons in the selected one of the plurality of stored courses when modifying the presentation of the course content.

17. The method of claim 10, further comprising allowing the institution to modify the course content in the selected one of the plurality of stored courses when modifying the presentation of the course content.

18. The method of claim 1, wherein the course content is selected from the group comprising text, graphics, audio, or video.

19. A system for enabling a student to participate in an educational course over a network at a pace determined by the student, the system comprising:
a data storage area for storing course content, the course content comprising teaching materials and testing materials;
a mapping module coupled to the data storage area and maintaining an association between a plurality of courses and stored course content associated with each of the plurality of courses, at least some of the plurality of courses being divided into one or more lessons; and
a course delivery module coupled to the mapping module, the course delivery module accessing course content associated with a course that is divided into two or more lessons and delivering the course content over a network to a student enrolled in the course, wherein the student is allowed to receive the two or more lessons in any order and there is no end date by which the student is required to complete the delivered course.

20. The system of claim 19, wherein the course may have one or more gating events associated with the course.

21. The system of claim 20, wherein the gating events are associated with the one or more lessons and the student is not allowed to proceed to a next lesson unless the requirements of the gating events associated with a current lesson have been met.

22. The system of claim 20, further comprising a security module that limits access to a course to authorized students.

23. The system of claim 20, wherein the data storage area further stores a course status associated with the course that is delivered to the student, the stored course status maintaining the progress of the student in the course and enabling the student to start and stop the course at the discretion of the student.

24. A system for enabling a student to participate in an educational course over a network at a pace determined by the student, the system comprising:
a data storage area for storing course content and course parameters, the course content comprising teaching material and testing material, the course parameters comprising a course duration;
a mapping module coupled to the data storage area and maintaining an association between a plurality of courses and stored course content and course parameters associated with each of the plurality of courses, at least some of the plurality of courses being divided into one or more lessons; and
a course delivery module coupled to the mapping module, the course delivery module accessing course content and course parameters associated with a course that is divided into two or more lessons and delivering the course content in accordance with the course parameters over a network to a student enrolled in the course, wherein the student is allowed to receive the two or more lessons in any order and the student is required to complete the course within the course duration specified by the course parameters.

25. The system of claim 24, wherein the course duration begins when the course is initially available for delivery over the network.

26. The system of claim 24, wherein the course may have one or more gating events associated with the course.

27. The system of claim 26, wherein the gating events are associated with the one or more lessons and the student is not allowed to proceed to a next lesson unless the requirements of the gating events associated with a current lesson have been met.

28. The system of claim 24, wherein the data storage area further stores a course status associated with the course that is delivered to the student, the stored course status maintaining the progress of the student in the course and enabling the student to start and stop the course at the discretion of the student.
